(19) United States
(12) Patent Application Publication
(10) Pub. No.: US 2011/0132848 A1
(43) Pub. Date: Jun. 9, 2011

(54) APPARATUS AND METHOD FOR CHLORINATING SWIMMING POOLS

(76) Inventor: Pedro J. Diaz, Tempe, AZ (US)

(21) Appl. No.: 12/821,300

(22) Filed: Jun. 23, 2010

Related U.S. Application Data
(60) Provisional application No. 61/267,428, filed on Dec. 7, 2009.

(51) Int. Cl. C02F 1/68

(52) U.S. Cl. 210/764; 210/198.1

(57) ABSTRACT

A submersible apparatus, having at least one aperture formed in the body of the apparatus and one or more sanitizing or disinfecting tablets being contained within the apparatus, is placed into a swimming pool or other body of water. Initially, the combined mass of the apparatus and the chlorine tablets contained within the body of the apparatus will have slightly negative buoyancy and, as the apparatus sinks into the water, the position of the apparatus will stabilize (e.g., reach neutral buoyancy) at a position at or near the bottom of the swimming pool. As the chlorine tablets interact with the water in the swimming pool and slowly dissolve, the buoyancy of the apparatus increases (becomes more positive) and the apparatus gradually rises vertically until it reaches the surface of the swimming pool.

### CROSS REFERENCE TO RELATED APPLICATION

This non-provisional patent application claims the benefit of U.S. Provisional Patent Application Ser. No. 61/267,428, under 35 U.S.C. §120, which application was filed on 7 Dec. 2009, which application is now pending and which application is incorporated by reference herein.

### BACKGROUND OF THE INVENTION

1. Technical Field

The present invention relates generally to swimming pools and more specifically relates to disinfecting water contained in swimming pools.

2. Background Art

Chemicals used for swimming pool water disinfection must meet certain conditions in order to be useful. They should be relatively harmless and non-irritating to swimmers and attendants. They must be active in small concentrations and remain their activity for a relatively long period of time. Contrary to drinking water disinfectants, disinfectants used for swimming pool treatment must be active in the pool itself, because pollutions and pathogenic microorganisms are constantly added to the water. Therefore, it is necessary for the water to maintain a residual disinfectant concentration. The disinfectant should also be easily traced and measured and should be safe to store and use under normal operating circumstances.

Chlorine-based disinfectants are among the most frequently applied disinfectants and oxidizers for swimming pool treatment. Generally, chlorine [hypochlorous acid (HOCl) or hypochlorite (OCl⁻)] in the form of liquid or tablets is introduced into a swimming pool or other body of water in order to minimize the growth of undesirable algae, bacteria, mold, etc.

It is desirable to keep the concentration of chlorine in the swimming pool at a relatively stable level because either too much chlorine or too little chlorine can cause problems. The level of chlorine needs to remain relatively high because if the concentration of chlorine in the swimming is too low, the water will be unsafe for swimmers. However, if the concentration of chlorine is too high, the excess chlorine can cause eye and mucous membrane irritation, as a result of chloramine formation.

Although standards for chlorine concentration in swimming pools vary, one typical threshold for available chlorine sets a minimum concentration for swimming pools at 0.5 mg/l. A typical maximum threshold level is set to 1.5 mg/l. When using cyanic acid as a stabilizer, atypical minimum and maximum threshold values might be set respectively at 2.0 mg/1 and 5.0 mg/L. For outdoor swimming pools and indoor pools smaller than 20 m², the maximum chlorine concentration level may be set to 5.0 mg/l.

While there are a number of devices and methods used for stabilizing the chlorine concentration in swimming pools, most fall short in one or more ways. For example, it is not uncommon to introduce liquid chlorine directly into the water. However, liquid chlorine can be very corrosive and caustic. Containers of liquid chlorine can also release chlorine gas when opened, so it is important to avoid breathing the fumes. Finally, liquid chlorine may be difficult to store over long periods of time.

Another popular chlorination method involves the use of chlorine in the form of small tablets. This method uses a “floater” device to contain the tablets for use in the swimming pool. Often manufactured in the shape of a duck or small cylindrical device, this buoyant product is designed to hold one or more chlorine tablets and float on the surface when it is placed into a body of water (e.g., swimming pool). A number of apertures or openings are typically formed in the body of the floater device and water from the swimming pool is allowed to flow though the openings, contacting the chlorine tablets and, as the chlorine tablets dissolve, chlorine is introduced into the water contained in the body of water.

While this device successfully adds chlorine to the water, there are a number of problems. Since the device floats on the surface of the water, the chlorine is added to the surface of the water where, depending on the ambient conditions, it may rapidly dissipate into the surrounding atmosphere. Additionally, the device is designed to float on the surface, making it an attractive target for young children who may view the device as a “toy” to be played with. Prolonged contact with the chlorine tablets may cause harm to any child who handles the device. Further, it is relatively difficult, if not impossible, to determine when or if the chlorine tablets contained inside the floating device have completely dissolved. This means that the floating device may be empty for some period of time and no chlorine will be added to the swimming pool until someone remembers to check the device to determine that the tablets have dissolved. So, while relatively simple to use, the floating chlorination device is far from perfect.

Accordingly, without additional improvements in the equipment and methods used in swimming pool chlorination, the ability of swimming pool owners and operators to stabilize chlorine levels at desirable levels will remain suboptimal.

### BRIEF SUMMARY OF THE INVENTION

An apparatus for enhanced chlorination of bodies of water (e.g., swimming pools) is disclosed. The apparatus has a variable total mass (and buoyancy) based on the combination of the mass of at least one chlorine tablet placed into the body of the apparatus and the inherent mass of the apparatus itself. When the apparatus, with the chlorine tablet(s) inside, is placed into the swimming pool, the apparatus sinks towards the bottom of the swimming pool. As the chlorine tablet(s) dissolve, chlorine is released into the water contained into the swimming pool and the apparatus begins to rise towards the surface of the pool. Once all or substantially all of the chlorine tablet(s) have dissolved, the apparatus reaches the surface of the pool where it signals the need to place more chlorine tablet(s) into the apparatus. Once the apparatus has been refilled with chlorine tablets, it can be simply placed back into the swimming pool.

### BRIEF DESCRIPTION OF THE FIGURES

The preferred embodiments of the present invention will hereinafter be described in conjunction with the appended drawings, wherein like designations denote like elements, and:

FIG. 1 shows an apparatus for chlorinating swimming pools in accordance with a preferred exemplary embodiment of the present invention;

FIG. 2 shows an apparatus for chlorinating swimming pools in accordance with a preferred exemplary embodiment of the present invention;

FIG. 3 shows an apparatus for chlorinating swimming pools in accordance with a preferred exemplary embodiment of the present invention;

FIG. 4 shows an apparatus for chlorinating swimming pools in accordance with a preferred exemplary embodiment of the present invention;

FIG. 5 shows an apparatus for chlorinating swimming pools in accordance with a preferred exemplary embodiment of the present invention;

FIG. 6 shows a cap portion of an apparatus for chlorinating swimming pools in accordance with a preferred exemplary embodiment of the present invention; and

FIG. 7 shows a method for chlorinating swimming pools in accordance with a preferred exemplary embodiment of the present invention;

### DETAILED DESCRIPTION

In general, according to the fifth proposition of Archimedes, any object, wholly or partially immersed in a fluid, is buoyed up by a force equal to the weight of the fluid displaced by the object. In the real world, this principle is observed by noticing that an object tends to become more buoyant in water as it loses mass, due to the relationship between mass and weight.

In accordance with the most preferred embodiments of the present invention, an apparatus is configured to accept one or more chlorine tablets into the body of the apparatus. When the apparatus, with the chlorine tablets inside, is placed into the swimming pool, the apparatus sinks towards the bottom of the swimming pool. The combined weight/mass of the chlorine tablet and the apparatus changes over time as the chlorine tablets inside the apparatus dissolve. As the chlorine tablets dissolve, chlorine is released into the water contained into the swimming pool and the apparatus begins to rise towards the surface of the pool. Once all or substantially all of the chlorine tablet(s) have dissolved, the apparatus reaches the surface of the pool where it signals the need to place more chlorine tablet(s) into the apparatus.

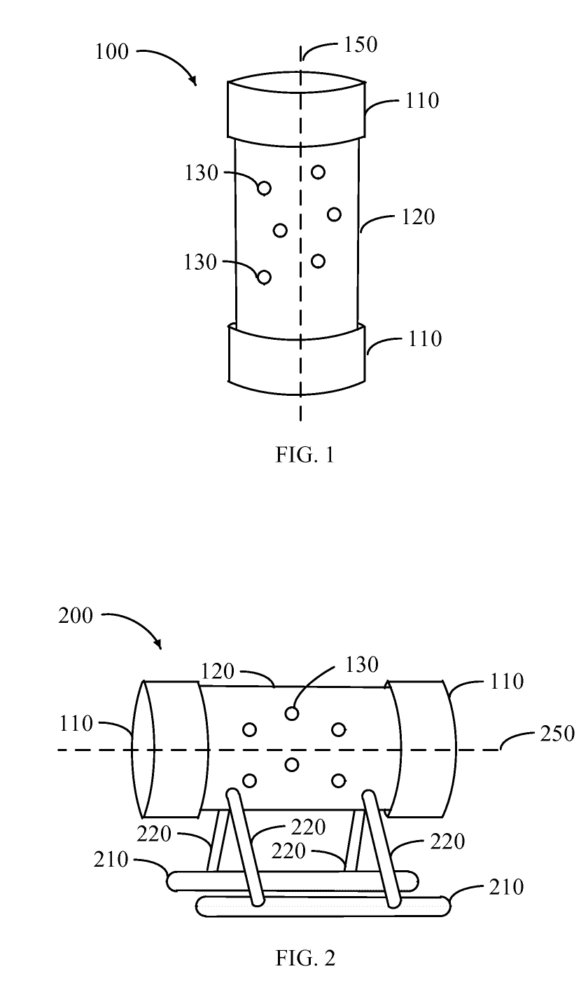

Referring now to FIG. 1, an apparatus 100 for chlorinating swimming pools in accordance with a first preferred exemplary embodiment of the present invention is depicted. As shown in FIG. 1, apparatus 100 comprises a pair of caps 110 fitted onto a substantially cylindrical hollow body 120. Apparatus 100 is substantially capsule-shaped, with the overall appearance of an elongated spheroid. Body 120 comprises a plurality of apertures 130. The interior space of apparatus 100 can be accessed by removing one or more of caps 100. Caps 120 may be attached to body 120 by compression fit. Alternatively, in at least one preferred embodiment of the present invention, body 120 and caps 110 may be manufactured with cooperating screw threads so that caps 110 may be screwed onto body 110, similar to the process used in screwing nuts onto threaded bolts. The mass of apparatus 100 is calculated so that apparatus 100 will be buoyant and float on the surface of the water contained in a swimming pool when the interior space of apparatus 100 is empty.

When apparatus 100 is to be deployed for chlorinating the water in the swimming pool, one or more of caps 110 may be removed and the interior space of body 120 is provided with one or more chlorine tablets (not shown this FIG.). The inner diameter of body 120 is manufactured to be compatible with the outer diameter of standard chlorine tablets, allowing the chlorine tablets to be positioned within the interior space of apparatus 100. The addition of the chlorine tablets to the interior space of body 120 will increase the effective mass of apparatus 100, thereby creating a less buoyant apparatus 100.

When placed into a body of water, apparatus 100 will gradually sink towards the bottom of the swimming pool by virtue of the combined mass of apparatus 100 and the chlorine tablets that have been positioned inside apparatus 100. Further, once apparatus 100 has been placed into the water, water will enter body 120 via apertures 130, allowing the water to contact the surface of the chlorine tablets. The chlorine tablets will gradually dissolve and release chlorine into the water via apertures 130, thereby chlorinating and disinfecting the water. As the chlorine tablets dissolve, the combined mass of apparatus 100 and the chlorine tablets will be reduced and less water will be displaced by apparatus 100. The result will be that apparatus 100 will gradually rise to the surface of the water, chlorinating the water as it rises. By controlling the number of apertures 130 formed in body 120 and by controlling the number of chlorine tablets placed into body 120, the appropriate amount of chlorine for various amounts of water can be provided by apparatus 100. In the most preferred embodiments of the present invention, apparatus 100 will be configured with some type of buoyant material in one cap 100, thereby urging apparatus 100 to maintain a substantially vertical position in the water along a vertical axis 150.

Referring now to FIG. 2, an alternative preferred embodiment of an apparatus for chlorinating swimming pools is depicted. As shown in FIG. 2, apparatus 200 is similar to apparatus 100 of FIG. 1 except that apparatus 200 has been fitted with a pair of skids 210. Skids 210 are affixed to body 120 by struts 220. Skids 210 may be substantially cylindrical and be fitted with ballast. This configuration will provide a horizontal orientation for apparatus 200 in the water. Skids 210 are configured to prevent body 120 from contacting the bottom surface of the swimming pool. As shown in FIG. 2, longitudinal axis 250 will be substantially parallel with the surface of the body of water into which apparatus 200 has been placed. In this configuration, body 120 may be configured as a two-part body 120. The two pieces of body 120 may be defined as an upper body section and a lower body section where the upper body section and lower body section are each a half-cylinder, joined together at longitudinal axis 250. Cap portions 110 will be sized so that the inner diameter of cap portions 110 will be just larger than the diameter of the upper body section and a lower body section. This will allow cap portions 110 to fit over the upper body section and a lower body section of body 120 and thereby hold upper body section and a lower body section together.

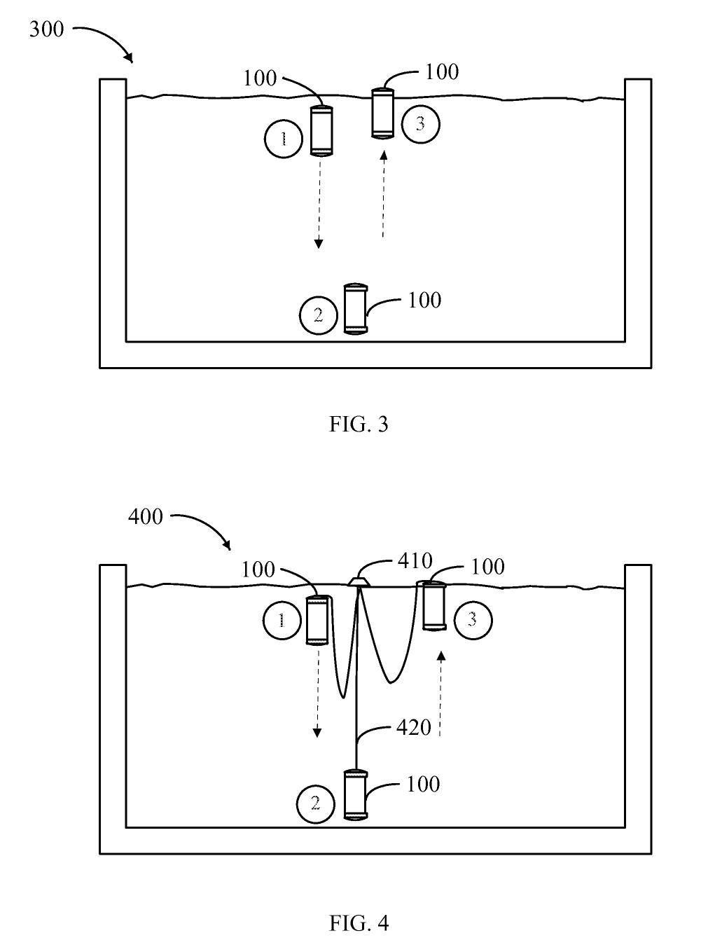

Referring now to FIG. 3, a schematic diagram of a swimming pool 300 being chlorinated by apparatus 100 of FIG. 1 is depicted. Apparatus 100 is placed into swimming pool 300 at position 1 and, due to the combined mass of apparatus 100 and the chlorine tablets placed inside apparatus 100, apparatus 100 will gradually sink to position 2. The combined mass of apparatus 100 and the chlorine tablets placed within apparatus 100 will be calculated so as to ensure that apparatus 100 will be suspended slightly above the floor of swimming pool 300 at position 2, thereby preventing apparatus 100 from contacting the bottom surface of swimming pool 300. As previously explained, the chlorine tablets inside apparatus 100 will gradually dissolve and, due to the reduced mass, apparatus 100 will gradually rise towards the surface of swimming pool 300 until it reaches position 3. Once apparatus 100 reaches position 3, the operator of swimming pool 300 will be visually notified that apparatus 100 has returned to the surface and apparatus can be filled with additional chlorine tablets and re-deployed.

Referring now to FIG. 4, a schematic diagram of a swimming pool 400 being chlorinated by an alternative preferred embodiment of apparatus 100 of FIG. 1 is depicted. As shown in FIG. 4, apparatus 100 of FIG. 1 has been connected to a floatation device 410 by a flexible cord 420. Floatation device 410 is buoyant enough to float on the surface of the swimming pool, even when apparatus 100 has been filled with chlorine tablets. Apparatus 100 is placed into swimming pool 400 at position 1 and, due to the combined mass of apparatus 100 and the chlorine tablets placed inside apparatus 100, apparatus 100 will gradually sink to position 2. The length of flexible cord 420 is fixed so as to ensure that apparatus 100 will be suspended slightly above the floor of swimming pool 400 at position 2, thereby preventing apparatus 100 from contacting the bottom surface of swimming pool 400. As previously explained, the chlorine tablets inside apparatus 100 will gradually dissolve and, due to the reduced mass, apparatus 100 will gradually rise towards the surface of swimming pool 400 until it reaches postion 3. Once apparatus 100 reaches position 3, the operator of swimming pool 400 will be visually notified that apparatus 100 has returned to the surface and apparatus can be filled with additional chlorine tablets and re-deployed.

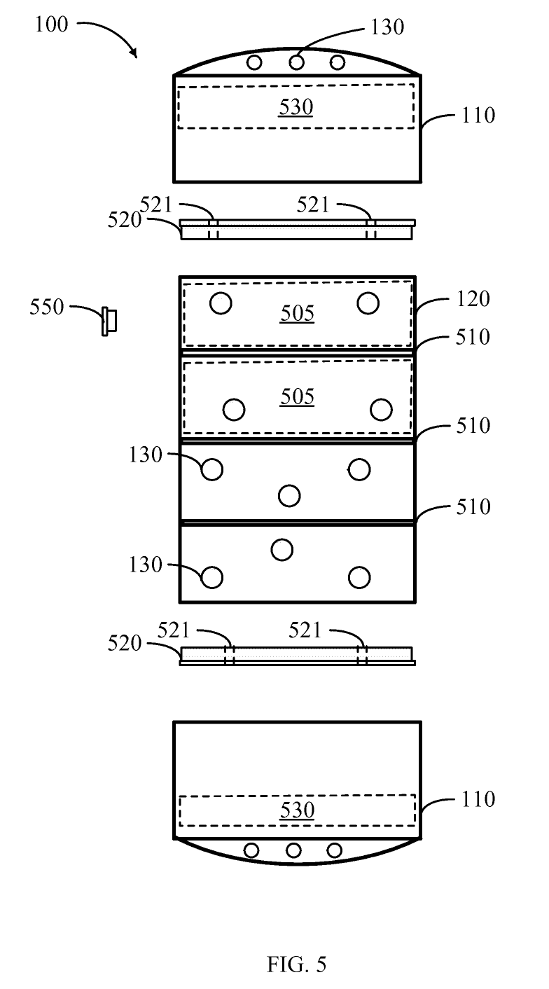

Referring now to FIG. 5, an cutaway exploded view of an apparatus 500 for chlorinating swimming pools in accordance with a preferred embodiment of the present invention is depicted. Apparatus 500 is similar to apparatus 100 of FIG. 1. As shown in FIG. 5, apparatus 500 has caps 110 and a body 120. Additionally, floatation material 530 is contained within caps 110. Floatation material 530 is a buoyant material (e.g., Styrofoam™) that provides the appropriate level of buoyancy for apparatus 500. In the most preferred embodiments of the present invention, more floatation material 530 will be placed in one cap 110 than the other cap 110. This configuration will ensure that, if desired, apparatus 500 remains in a substantially vertical orientation along its longitudinal axis.

As shown in FIG. 5, one or more chlorine tablets 505 have been placed into body 120 of apparatus 500. Additionally, one or more plugs 550 may be provided to plug one or more apertures 130. By plugging one or more apertures 130, the amount of water that enters body 120 can be controlled, thereby adjusting the amount of water that contacts the surface of chlorine tablets 505. This allows the operator to increase or decrease the rate of dissolution for chlorine tablets 505, to ensure that the rate of chlorination is always maintained at an optimal level for a given swimming pool. Spacers 510 may be positioned inside body 120 and between chlorine tablets 505 to hold tablets 505 in the desired orientation and position. End caps 520, fitted with apertures 521, may be used to hold chlorine tablets 505 and spacers 510 in position inside body 120. In the most preferred embodiments of the present invention, spacers 510 may be circular disks with perforations, or simply “fingers” that extend from one edge of the interior space of body 120 to the other edge of the interior space of body 120. Spacers 510 serve to keep chlorine tablets 505 in a vertical position (e.g., at approximately a 90° angle relative to longitudinal axis 250 of FIG. 2).

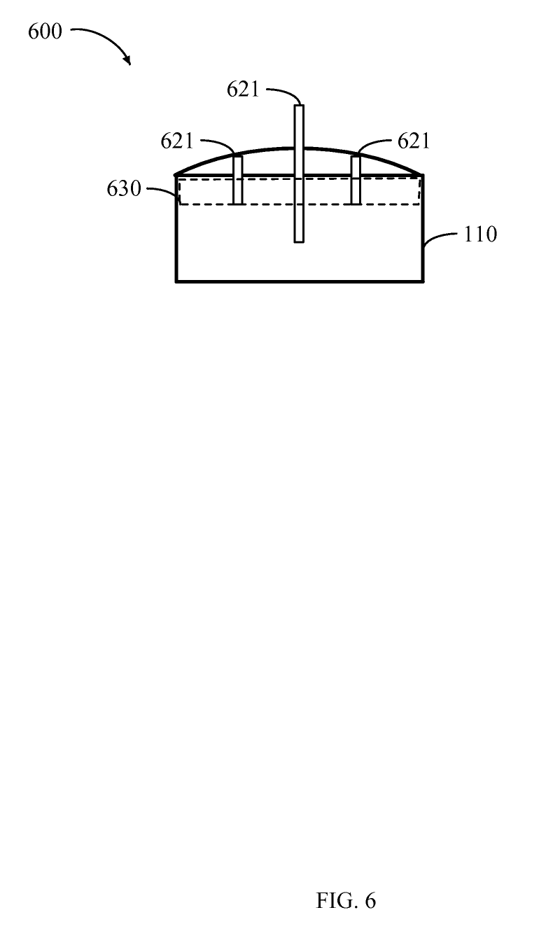

Referring now to FIG. 6, an alternative preferred embodiment of a cap or cap portion 110 is depicted. In this embodiment of the present invention, a plurality of capillary tubes 621 (e.g. straws) are positioned inside cap portion 110. By varying the length of capillary tubes 621, a desired amount of head space 630 (e.g. air pocket) may be maintained inside of cap 110. This provides buoyancy for apparatus 100 of FIG. 1 or apparatus 500 and may be used instead of floatation material 530 of FIG. 5. Additionally, one or more tubes 621 may extend above the uppermost part of cap 110, thereby providing a conduit or pathway for chlorine to escape from the interior of body 120 into the surrounding water.

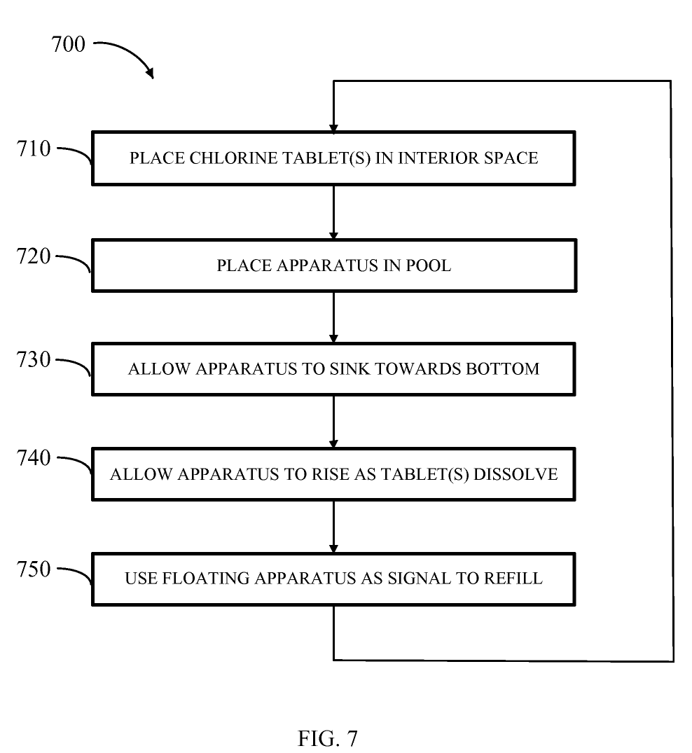

Referring now to FIG. 7, a method 700 for chlorinating a swimming pool using an apparatus in accordance with a preferred exemplary embodiment of the present invention is depicted. As shown in FIG. 7, one or more chlorine tablets are placed inside the body of the apparatus (step 710). After the chlorine tablets are in place, the apparatus is placed into the swimming pool (step 720). Due to the combined mass of the apparatus and the chlorine tablets, the apparatus will gradually sink towards the bottom of the swimming pool until it reaches a point of near zero buoyancy close to the bottom of the swimming pool (step 730).

Once in the water, the chlorine tablets in the interior space of the apparatus will gradually be dissolved via surface contact with the water in the swimming pool (step 740) and the chlorine from the dissolving tablet(s) will provide chlorination for the water in the swimming pool and, as that combined mass of the apparatus and the chlorine tablets is reduced, the apparatus will begin to rise towards the surface of the water (step 750). Once the apparatus is once again floating at or near the surface of the water, the operator of the swimming pool will be able to make visual contact with the apparatus and the cycle of method 700 can be repeated.

From the foregoing description, it should be appreciated that an enhanced apparatus and methods for chlorinating swimming pools is provided by the various preferred embodiments of the present invention and that the various preferred embodiments offer significant benefits that would be apparent to one skilled in the art. Furthermore, while multiple preferred embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. An apparatus comprising:
a hollow cylindrical body, said hollow cylindrical body defining at least one aperture;
first cap, said first cap being positioned over a first end of said cylindrical body;
a second cap, said second cap being positioned over a second end of said cylindrical body, wherein said hollow cylindrical body and said first cap and said second cap define an interior space within said hollow cylindrical body;
at least one chlorine tablet contained with said interior space, said at least one chlorine tablet and said apparatus defining an initial mass wherein said apparatus and said at least one chlorine tablet are placed into a body of water and stabilize at a first position, wherein at least a portion of said body of water enters said apparatus via said aperture and contacts said at least one chlorine tablet, thereby dissolving at least a portion of said at least one chlorine tablet over a period of time, thereby altering said initial mass to create a subsequent mass, said subsequent mass being less than said initial mass, wherein said apparatus rises to a second position within said body of water, said second position being at a relatively higher elevation than said first position.

2. The apparatus of claim 1 wherein said apparatus further comprises a plurality of floatation material, with a first amount of floatation material being placed inside said first cap and a second amount of floatation material being placed inside said second cap, wherein said first amount of floatation material is greater than said second amount of floatation material, thereby urging said hollow cylindrical body to stabilize in a relatively vertical orientation along a longitudinal axis of said hollow cylindrical body.

3. The apparatus of claim 1 wherein said at least one chlorine tablet comprises a plurality of chlorine tablets.

4. The apparatus of claim 1 wherein said first cap comprises a plurality of capillary tubes, wherein at least one of said plurality of capillary tubes comprises a conduit for transmission of chlorine gas from said interior space to said body of water.

5. The apparatus of claim 1 wherein said hollow cylindrical body comprises an upper body section and a lower body section.

6. The apparatus of claim 1 wherein said at least one aperture comprises a plurality of apertures.

7. The apparatus of claim 1 further comprising at least a pair of skids being affixed to an exterior surface of said hollow cylindrical body, said at least a pair of skids being configured to prevent said hollow cylindrical body from contacting a bottom surface of said body of water.

8. The apparatus of claim 1 further comprising at least one spacer, said at least one spacer being configured to hold said at least one chlorine tablet in a vertical orientation relative to a longitudinal axis of said hollow cylindrical body.

9. The apparatus of claim 1 further comprising a pair of end caps, wherein each of said pair of end caps is positioned at an end of said hollow cylindrical body.

10. The apparatus of claim 1 further comprising:
at least a pair of skids being affixed to an exterior surface of said hollow cylindrical body, said at least a pair of skids being configured to prevent said hollow cylindrical body from contacting a bottom surface of said body of water and wherein said hollow cylindrical body comprises an upper body section and a lower body section and wherein said at least one aperture comprises a plurality of apertures and wherein said first cap comprises a plurality of capillary tubes, wherein at least one of said plurality of capillary tubes comprises a conduit for transmission of chlorine gas from said interior space to said body of water and wherein said at least one chlorine tablet comprises a plurality of chlorine tablets;
at least one spacer, said at least one spacer being configured to hold said at least one chlorine tablet in a vertical orientation relative to a longitudinal axis of said hollow cylindrical body; and
a pair of end caps, wherein each of said pair of end caps is positioned at an end of said hollow cylindrical body.

11. A method of chlorinating a body of water, said method comprising the step of placing an apparatus in said body of water, said apparatus comprising:
a hollow cylindrical body, said hollow cylindrical body defining at least one aperture;
a first cap, said first cap being positioned over a first end of said cylindrical body;
a second cap, said second cap being positioned over a second end of said cylindrical body, wherein said hollow cylindrical body and said first cap and said second cap define an interior space within said hollow cylindrical body;
at least one chlorine tablet contained with said interior space, said at least one chlorine tablet and said apparatus defining an initial mass wherein said apparatus and said at least one chlorine tablet are placed into a body of water and stabilize at a first position, wherein at least a portion of said body of water enters said apparatus via said aperture and contacts said at least one chlorine tablet, thereby dissolving at least a portion of said at least one chlorine tablet over a period of time, thereby altering said initial mass to create a subsequent mass, said subsequent mass being less than said initial mass, wherein said apparatus rises to a second position within said body of water, said second position being at a relatively higher elevation than said first position.

12. The method of claim 11 wherein said apparatus further comprises a plurality of floatation material, with a first amount of floatation material being placed inside said first cap and a second amount of floatation material being placed inside said second cap, wherein said first amount of floatation material is greater than said second amount of floatation material, thereby urging said hollow cylindrical body to stabilize in a relatively vertical orientation along a longitudinal axis of said hollow cylindrical body.

13. The method of claim 11 wherein said at least one chlorine tablet comprises a plurality of chlorine tablets.

14. The method of claim 11 wherein said first cap comprises a plurality of capillary tubes, wherein at least one of said plurality of capillary tubes comprises a conduit for transmission of chlorine gas from said interior space to said body of water.

15. The method of claim 11 wherein said hollow cylindrical body comprises an upper body section and a lower body section.

16. The method of claim 11 wherein said at least one aperture comprises a plurality of apertures.

17. The method of claim 11 wherein said apparatus further comprises at least a pair of skids being affixed to an exterior surface of said hollow cylindrical body, said at least a pair of skids being configured to prevent said hollow cylindrical body from contacting a bottom surface of said body of water.

18. The method of claim 11 wherein said apparatus further comprises at least one spacer, said at least one spacer being configured to hold said at least one chlorine tablet in a vertical orientation relative to a longitudinal axis of said hollow cylindrical body.

19. The method of claim 11 wherein said apparatus further comprises a pair of end caps, wherein each of said pair of end caps is positioned at an end of said hollow cylindrical body.

20. The method of claim 11 wherein said apparatus further comprises:
at least a pair of skids being affixed to an exterior surface of said hollow cylindrical body, said at least a pair of skids being configured to prevent said hollow cylindrical body from contacting a bottom surface of said body of water and wherein said hollow cylindrical body comprises an upper body section and a lower body section and wherein said at least one aperture comprises a plurality of apertures and wherein said first cap comprises a plurality of capillary tubes, wherein at least one of said plurality of capillary tubes comprises a conduit for transmission of chlorine gas from said interior space to said body of water and wherein said at least one chlorine tablet comprises a plurality of chlorine tablets;
at least one spacer, said at least one spacer being configured to hold said at least one chlorine tablet in a vertical orientation relative to a longitudinal axis of said hollow cylindrical body; and
a pair of end caps, wherein each of said pair of end caps is positioned at an end of said hollow cylindrical body.
